(19) United States
(12) Patent Application Publication
(10) Pub. No.: US 2026/0208090 A1
(43) Pub. Date: Jul. 23, 2026

(54) FILTER ELEMENT

(71) Applicant: MANN+HUMMEL GmbH, Ludwigsburg (DE)

(72) Inventors: Lucas TOCACHELLI, Sao Paulo (BR); Luiz Carlos FRITZ, Sao Paulo (BR); Marcos Roberto SOARES, Sao Paulo (BR)

(21) Appl. No.: 19/571,158

(22) Filed: Mar. 18, 2026

Related U.S. Application Data
(63) Continuation of application No. PCT/EP2024/078319, filed on Oct. 9, 2024.

(30) Foreign Application Priority Data
Oct. 9, 2023 (DE) 10 2023 127 453.8

(51) Int. Cl. B01D 46/52

(52) U.S. Cl. CPC B01D 46/523

(57) ABSTRACT

A filter element, for example an air filter element, includes a pleated filter media bellows extending at least partially circumferentially about a longitudinal axis, wherein pleats of the filter media bellows extend essentially parallel to the longitudinal axis. The filter media bellows includes inner pleat folds at an inner circumference and outer pleat folds at an outer circumference. At least one inner pleat fold and at least one outer pleat fold each include a pleat lock deformation with an extension along the longitudinal axis that is smaller than a total longitudinal extension (30) of the filter media bellows.

### CROSS-REFERENCE TO RELATED APPLICATIONS

This application is a continuation application of international application No. PCT/EP2024/078319 having an international filing date of Oct. 9, 2024, and designating the United States, the international application claiming a priority date of Oct. 9, 2023, based on German patent application No. DE 10 2023 127 453.8, the entire contents of the aforesaid applications being incorporated herein by reference to the fullest extent permissible.

### TECHNICAL FIELD

The invention relates to a filter element, for example an air filter element.

### BACKGROUND

Cylindrical filter elements, for example air filter elements, with pleated filter media bellows are known in the art.

Pleat locks are applied for stabilization in the external area of the filter element. Pleat rollers with pleat lock technology known in the art are used for manufacturing such filter media bellows.

### SUMMARY

It is an object of the invention to provide an improved filter element having pleat locks, for example an air filter element having pleat locks.

According to an aspect of the invention the object is achieved by a filter element, for example an air filter element, including a pleated filter media bellows extending at least partially circumferentially about a longitudinal axis, wherein pleats of the filter media bellows extend essentially parallel to the longitudinal axis, and wherein the filter media bellows includes inner pleat folds at an inner circumference and outer pleat folds at an outer circumference, and wherein at least one inner pleat fold and at least one outer pleat fold each include a pleat lock deformation with an extension along the longitudinal axis that is smaller than a total longitudinal extension of the filter media bellows.

Embodiments are described in the following description and the accompanying drawings.

A filter element, for example an air filter element, is proposed, including a pleated filter media bellows extending at least partially circumferentially about a longitudinal axis, wherein pleats of the filter media bellows extend essentially parallel to the longitudinal axis. The filter media bellows includes inner pleat folds at an inner circumference and outer pleat folds at an outer circumference. At least one inner pleat fold and at least one outer pleat fold each include a pleat lock deformation with an extension along the longitudinal axis that is smaller than a total longitudinal extension of the filter media bellows.

Favorably, by modifying pleat rollers accordingly, at the time of creasing the filter media, e.g. paper, these have the capacity, by means of mechanical crushing forces, to also generate radial creases in specific areas of the bellows that are directed to the external region of the filter element.

In the proposed filter element, for example a cylindrical air filter element, a visual modification in the bottom geometry of the pleat of the filter media is present. This is possible by providing an inverted pleat lock linked to its realization in a specific filter medium, e.g., paper, bending head with a characteristic called pleat lock. This offers the ability to generate radial friezes along the filter media bellows. Pleat lock deformations are favorably present on the inner as well on the outer pleat folds.

Thus, the internal stabilization of the pleat fold is enhanced, which has the characteristic frieze of the pleat lock deformation more accentuated on the inner part of the filter media bellows. The pleat lock deformation has a visual aspect similar to a square, closing the central tube of the filter media bellows in a more uniform way and generating a greater possibility of sedimentation of the filtered dust at the bottom of the pleat.

The inverted pleat lock allows for a larger frieze in the inner part of the filter element, thus changing the internal geometry of the pleat, in contrast to the known art where this more pronounced frieze exists only in the external part of the filter element.

The pleat roller is adapted to perform radial pleats, so that by these pleats there is a better stabilization of the filter media bellows, having a more homogeneous distribution on the filter element. A better distribution of pleats provides a better visual aspect. It also allows to reduce the quantity of pleats without a loss of the dust holding capacity of the filter element.

An advantage of the proposed filter element is the internal stabilization of the pleats of the filter media bellows, which allows more dust to penetrate into the pleat and consequently generates more sedimentation in this area than in a conventional pleat without this specific pleat lock. In such conventional pleats having pleat locks at the outer side of the filter element, sedimentation is mainly located at the portion of the pleats closer to the outside of the filter element which may result in blocking the depth of the pleats and thus in reducing the filter area.

According to an embodiment of the filter element, the inner and outer pleat lock deformations may include a predefined depth, for example in a radial direction, a predefined length, for example in the longitudinal direction, and a predefined width, for example in a circumferential direction. Thus, the filter media bellows may be stabilized by the pleat lock deformations in very precise manner.

According to an embodiment of the filter element, the width of the inner pleat lock deformation may be larger than the width of the outer pleat lock deformation. Additionally or alternatively, the depth of the inner pleat lock deformation may be larger than the depth of the outer pleat lock deformation. With such a configuration of the pleat lock deformations the dust holding capacity of the pleats may favorably be enhanced and/or the quantity of pleats of a filter media bellows reduced.

According to an embodiment of the filter element, the width of the inner pleat lock deformation may be at least 20%, for example at least 25%, for example at least 30%, larger than the width of the outer pleat lock deformation. With such a configuration of the pleat lock deformations the dust holding capacity of the pleats may favorably be enhanced and/or the quantity of pleats of a filter media bellows reduced.

According to an embodiment of the filter element, the depth of the inner pleat lock deformation may be at least 30%, for example at least 35%, for example at least 40%, larger than the depth of the outer pleat lock deformation. Thus, stabilization of the pleats of the filter media bellows may further be enhanced.

According to an embodiment, the filter element may include additional inner pleat lock deformations at every n-th inner pleat fold, with n being a natural number. Thus, the filter media bellows may be stabilized by the pleat lock deformations in a very precise manner. For example, additional pleat lock deformations may be set at every second or every fourth of the pleats in order to achieve sufficient stability of the filter media bellows.

According to an embodiment, the filter element may include the inner pleat lock deformations at every inner pleat fold. By this way, a favorable stabilization of the pleats of the filter media bellows may be achieved.

According to an embodiment of the filter element, the width of a multitude of the inner pleat lock deformations may be larger on an average than the width of the outer pleat lock deformation. Additionally or alternatively, the depth of a multitude of the inner pleat lock deformations may be larger on an average than the depth of the outer pleat lock deformation. Thus, sufficient stabilization of the filter media bellows may be achieved.

According to an embodiment of the filter element, the width of a multitude of the inner pleat lock deformations may be at least 20%, for example at least 25%, for example at least 30%, larger on an average than the width of the outer pleat lock deformation. Thus, sufficient stabilization of the filter media bellows may be achieved.

According to an embodiment of the filter element, the depth of a multitude of the inner pleat lock deformations may be at least 30%, for example at least 35%, for example at least 40%, larger on an average than the depth of the outer pleat lock deformation. Thus, sufficient stabilization of the filter media bellows may be achieved.

According to an embodiment of the filter element, the inner pleat lock deformations may abut against each other at least in an intended state of use of the filter element. Thus, a limiting factor for pleat reduction may result. By this way, a maximum number of pleats in a filter bellow may be achieved. The inner dimension of the filter media bellows may favorably be stabilized.

According to an embodiment of the filter element, the inner pleat lock deformations may be arranged at the same longitudinal position so as to lie in a common plane, the common plane for example extending in a direction normal to the longitudinal axis. By this way, the filter media bellows may be stabilized in a favorable manner.

According to an embodiment of the filter element, multiple inner pleat lock deformations may be provided at a common inner pleat fold and are spaced apart from each other along the longitudinal direction. The proper stabilization of the filter media bellows may thus be chosen according to the number of pleat lock deformation per longitudinal dimension.

According to an embodiment of the filter element, the inner and/or outer pleat lock deformations may be formed as local geometry deviations of the inner and/or outer pleat fold in that a local pleat cross-section deviates from a pleat cross-section along a major part of the pleat's longitudinal extension. The deformations may be formed in a square-like manner. Thus, the pleat lock deformation may have a visual aspect similar to a square, closing the central tube of the filter media bellows in a more uniform way and generating a greater possibility of sedimentation of the filtered dust at the bottom of the pleat.

Favorably, the inner pleat lock deformation may include a minimum width of 1.8 mm, for example 1.9 mm, for example 2.0 mm and/or may include a minimum depth of 0.4 mm, for example 0.5 mm, for example 0.6 mm.

According to an embodiment of the filter element, the filter media bellows may include an outer pleat distance and an inner pleat distance, the pleat distance being measured as a distance between two neighboring pleat folds along the circumferential direction, wherein the inner pleat lock deformation may include a minimum width of 70%, for example of 75%, for example of 80%, for example 85%, of the inner pleat distance without pleat lock deformations. Thus, sufficient stabilization of the filter media bellows may be achieved.

According to an embodiment, the filter element may include at least one end body, for example an end cap, closing the filter media bellows at one axial end in a fluid-tight manner. Thus, a raw side of the filter element, usually the outer side of the filter media bellows, may be sealed against the clean side of the filter element, usually the inner side of the filter media bellows, when used in a housing of a filter system. For example, one end cap may be closed and the other end cap may have an opening as an outlet of the filtered fluid.

According to an embodiment, the filter element may include a fluid-permeable support body, for example a support grid, arranged at the inner circumference of the filter media bellows and extending at least partially in the circumferential direction. For example, the support body may be adapted and configured to support at least some of the inner pleat folds against deformation in the radial direction. The support body may further stabilize the filter media bellows against the fluid to be filtered.

### BRIEF DESCRIPTION OF THE DRAWINGS

The present invention together with the above-mentioned and other objects and advantages may best be understood from the following detailed description of embodiments, but not restricted to the embodiments, wherein is shown in:

FIG. 1 an isometric view of a pleated filter media bellows for a filter element, for example an air filter element, according to an embodiment of the invention;

FIG. 2 a side view of the pleated filter media bellows according to FIG. 1;

FIG. 3 a top view of the pleated filter media bellows according to FIG. 1, defining section planes IV-IV and V-V;

FIG. 4 a longitudinal section of the pleated filter media bellows according to section plane IV-IV in FIG. 3, depicting an inner pleat lock deformation;

FIG. 5 a longitudinal section of the pleated filter media bellows according to section plane V-V in FIG. 3, depicting an outer pleat lock deformation;

FIG. 6 a top view of the pleated filter media bellows according to FIG. 1, defining details VII and VIII;

FIG. 7 a cross section of the pleated filter media bellows according to detail VII in FIG. 6, depicting an outer pleat lock deformation;

FIG. 8 a cross section of the pleated filter media bellows according to detail VIII in FIG. 6, depicting an inner pleat lock deformation;

FIG. 9 a side view of the filter element with end caps according to an embodiment of the invention; and

FIG. 10 a top view of the pleated filter media bellows according to FIG. 1 with a support body.

### DETAILED DESCRIPTION

In the drawings, like elements are referred to with the same or similar reference numerals. The drawings are merely schematic representations, not intended to portray specific parameters of the invention. Moreover, the drawings are intended to depict only typical embodiments of the invention and therefore should not be considered as limiting the scope of the invention.

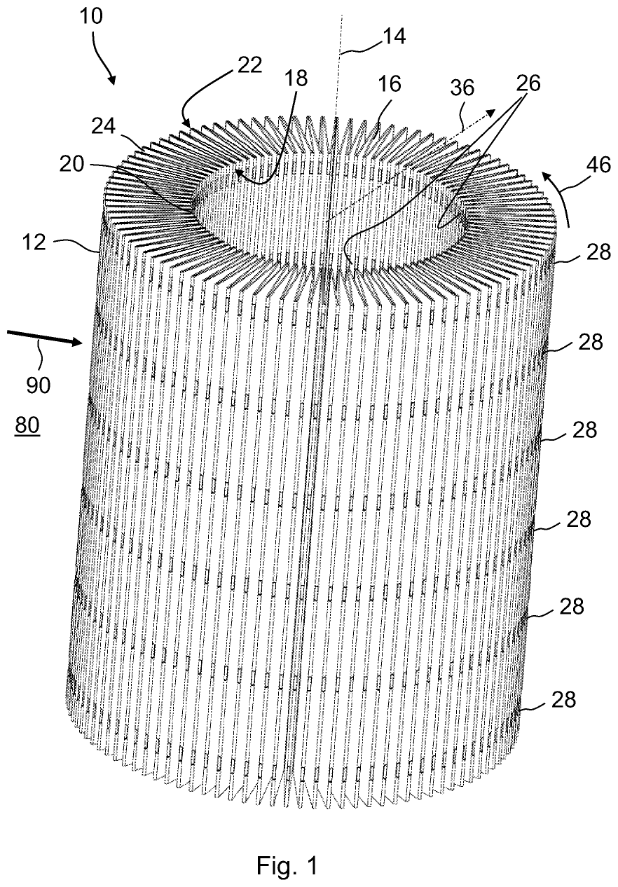

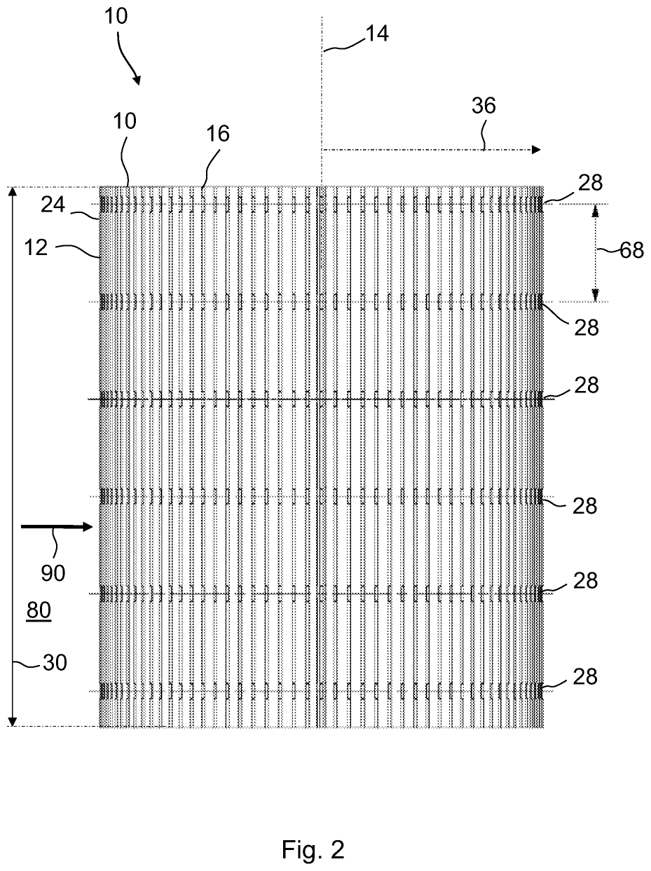

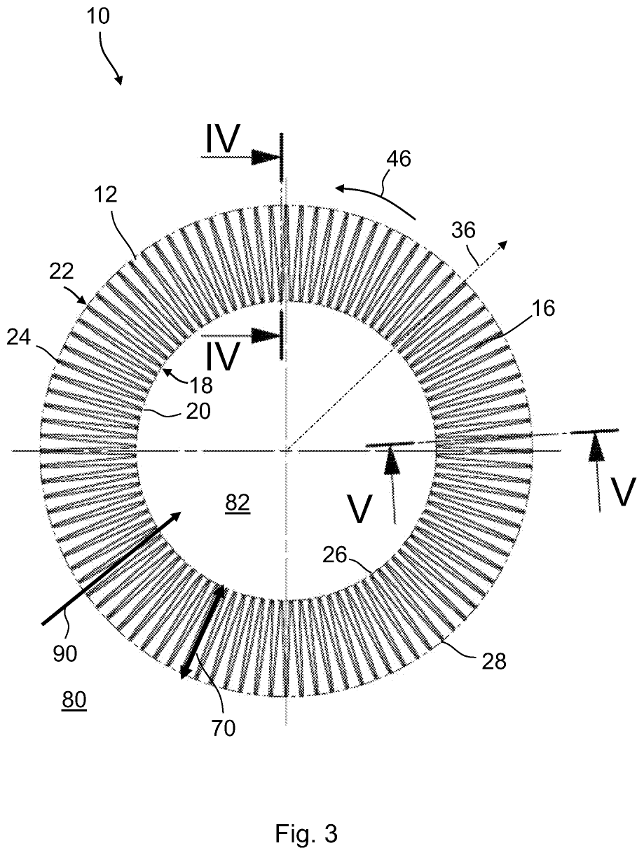

FIG. 1 depicts an isometric view of a pleated filter media bellows 12 for a filter element 10, for example an air filter element, according to an embodiment of the invention. In FIG. 2 a side view of the pleated filter media bellows 12 is depicted, whereas in FIG. 3 a top view of the pleated filter media bellows 12 is shown.

The filter element 10 comprises a pleated filter media bellows 12 in cylindrical form, extending at least partially circumferentially about a longitudinal axis 14. Pleats 16 of the filter media bellows 12 extend essentially parallel to the longitudinal axis 14. The filter media bellows 12 comprises inner pleat folds 20 at an inner circumference 18 and outer pleat folds 24 at an outer circumference 22.

As may be seen from FIG. 1 and FIG. 2, respectively, the inner pleat folds 20 and the outer pleat folds 24 each comprise a pleat lock deformation 26, 28 with an extension along the longitudinal axis 14 that is smaller than a total longitudinal extension 30 of the filter media bellows 12. In fact, in the embodiment shown, the extension along the longitudinal axis 14 is much smaller than a total longitudinal extension 30 of the filter media bellows 12.

Additional inner pleat lock deformations 26 may be provided at every n-th inner pleat fold 20, with n being a natural number. As may be seen from FIG. 1, the inner pleat lock deformations 26 are provided at every inner pleat fold 20.

As may be seen from the drawing figures, the filter media bellows 12 according to the embodiment shown, is provided with inner and/or outer pleat lock deformations 26, 28 arranged in six common planes along the extension of the filter media bellows 12 along the longitudinal axis 14. Inner and outer pleat folds 20, 24 are provided with pleat lock deformations 26, 28 on the same height regarding the height along the longitudinal axis 14.

Thus, the inner pleat lock deformations 26 are arranged at the same longitudinal position so as to lie in a common plane, the common plane for example extending in a direction normal to the longitudinal axis 14. Multiple inner pleat lock deformations 26 are provided at a common inner pleat fold 20 and are equally spaced apart from each other along the longitudinal direction 14. The same applies for the outer pleat lock deformations 28.

The distance 68 between the pleat lock deformations 26, 28, as shown in FIG. 2, may be e.g., 52 mm for filter media bellows 12 with a pleat height 70 (FIG. 3) between 25 mm and 48 mm, as measured normal to the longitudinal direction.

The fluid to be filtered enters the filter media bellows 12 from the raw side 80 outside of the filter media bellows 12 through the outer circumference 22 to the inner circumference 20 where the fluid enters the clean side 82 in an interior of the filter media bellows 12. The flow direction 90 is marked by an arrow.

As may be seen in FIG. 3, the inner pleat lock deformations 26 are still apart from each other. Yet in an embodiment, not shown in the drawing figures, the inner pleat lock deformations 26 may abut against each other at least in an intended state of use of the filter element 10, thus additionally stabilizing the inner side of the filter media bellows 12.

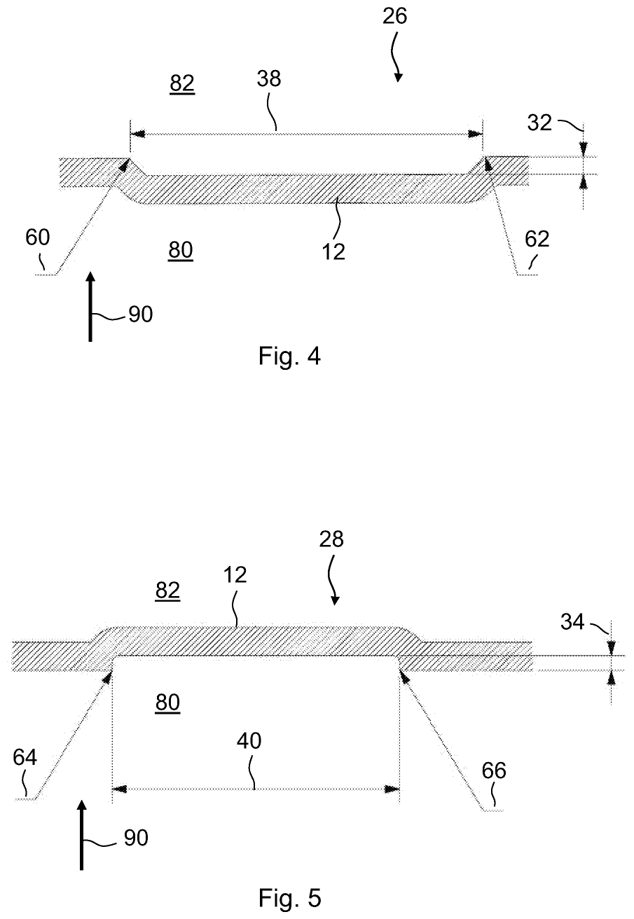

The inner and/or outer pleat lock deformations 26, 28 are formed as local geometry deviations of the inner and/or outer pleat fold 20, 24 in that a local pleat cross-section deviates from a pleat cross-section along a major part of the pleat's longitudinal extension. This may be seen from FIGS. 4 and 5, where longitudinal sections of the pleated filter media bellows 12 according to section planes IV-IV and V-V in FIG. 3, are shown, depicting an inner and an outer pleat lock deformation 26, 28.

FIG. 4 depicts a longitudinal section of the pleated filter media bellows 12 according to section plane IV-IV in FIG. 3, depicting an inner pleat lock deformation 26. The filter media is deformed into the interior of the filter media bellows 12 against the flow direction 90.

FIG. 5 depicts a longitudinal section of the pleated filter media bellows 12 according to section plane V-V in FIG. 3, depicting an outer pleat lock deformation 28. The filter media is deformed into the interior of the filter media bellows 12 in the flow direction 90.

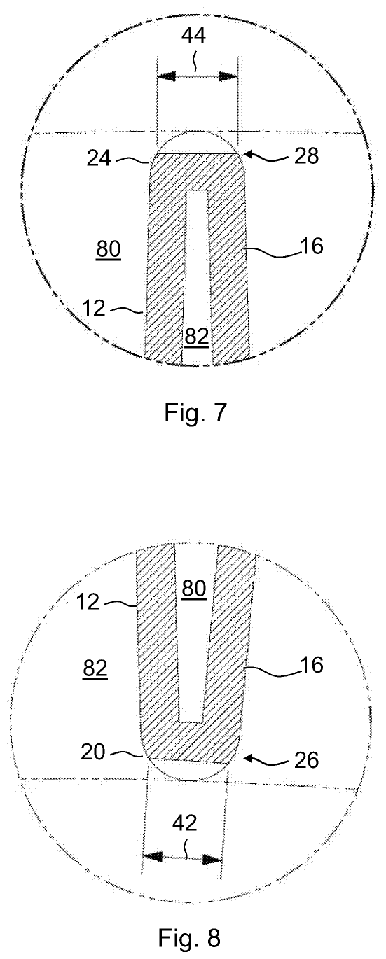

The inner and outer pleat lock deformations 26, 28 comprise a predefined depth 32, 34, for example in a radial direction 36, a predefined length 38, 40, for example in the longitudinal direction 14, and a predefined width 42, 44, (FIG. 8, FIG. 7) for example in a circumferential direction 46.

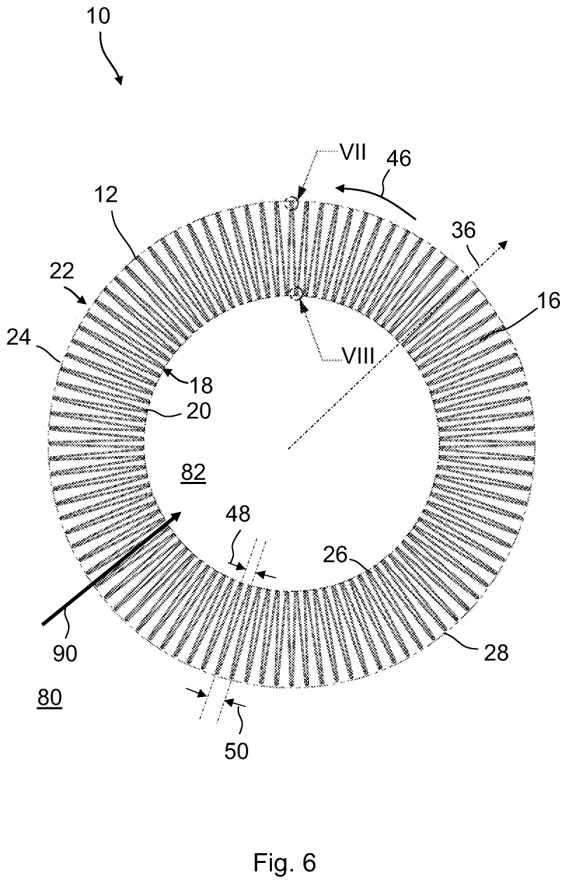

FIG. 6 depicts a top view of the pleated filter media bellows 12, defining details VII and VIII, which are shown in FIG. 7, where a cross section of the pleated filter media bellows 12 according to detail VII in FIG. 6 is depicted, and in FIG. 8, where a cross section of the pleated filter media bellows 12 according to detail VIII in FIG. 6 is depicted. FIG. 7 depicts an inner pleat lock deformation 26 and FIG. 8 depicts an outer pleat lock deformation 28.

As may be seen from both FIGS. 7 and 8, the pleat lock deformations 26, 28 mean a flattening of the original form of the outer and inner pleat folds 24, 20 of the respective pleat 16.

In FIGS. 4 and 5 as well as in FIGS. 7 and 8 a number of geometrical measures are defined, for example, embodiments of the proposed filter element 10. The geometrical measures are a length 38, 40, depth 32, 34, a width 42, 44 and angulations 60, 62, 64, 66 of the inner and outer pleat lock deformations 26, 28, respectively.

In the following table typical measures are given for four embodiments of the filter media bellows 12 with different pleat heights 70.

| | Reference | | | | | Unit of |
|---|---|---|---|---|---|---|
| | sign | | | | | measure |
| Pleat | 70 | 25 | 32 | 40 | 48 | mm |
| height | | | | | | |
| Length | 38 | 9.320 | 7.745 | 9.454 | 7.145 | mm |
| Length | 40 | 8.812 | 8.367 | 8.604 | 8.735 | mm |
| Depth | 32 | 0.678 | 0.574 | 0.581 | 0.633 | mm |
| Depth | 34 | 0.303 | 0.330 | 0.269 | 0.253 | mm |
| Width | 42 | 2.163 | 2.172 | 2.216 | 2.548 | mm |
| Width | 44 | 1.604 | 1.396 | 1.612 | 1.690 | mm |
| Angulation | 60 | 150 | 150 | 150 | 150 | degree |
| Angulation | 62 | 150 | 150 | 150 | 150 | degree |
| Angulation | 64 | 135 | 135 | 135 | 135 | degree |
| Angulation | 66 | 135 | 135 | 135 | 135 | degree |

The distance 68 between the pleat lock deformations 26, 28 for these embodiments is 52 mm in the longitudinal direction 14.

As may be seen from the values given in the table, the width 42 of the inner pleat lock deformation 26 may be larger than the width 44 of the outer pleat lock deformation 28 and/or the depth 32 of the inner pleat lock deformation 26 may be larger than the depth 34 of the outer pleat lock deformation 28.

Favorably, the width 42 of the inner pleat lock deformation 26 may be at least 20%, for example at least 25%, for example at least 30%, larger than the width 44 of the outer pleat lock deformation 28.

The depth 32 of the inner pleat lock deformation 26 may be at least 30%, for example at least 35%, for example at least 40%, larger than the depth 34 of the outer pleat lock deformation 28.

Also, as the measures of different pleats 16 may differ, the width 42 of a multitude of the inner pleat lock deformations 26 may be larger on an average than the width 44 of the outer pleat lock deformation 28 and/or the depth 32 of a multitude of the inner pleat lock deformations 26 may be larger on an average than the depth 34 of the outer pleat lock deformation 28.

Thus, the width 42 of a multitude of the inner pleat lock deformations 26 is at least 20%, for example at least 25%, for example at least 30%, larger on an average than the width 44 of the outer pleat lock deformation 28.

And the depth 32 of a multitude of the inner pleat lock deformations 26 may be at least 30%, for example at least 35%, for example at least 40%, larger on an average than the depth 34 of the outer pleat lock deformation 28.

An outer pleat distance 50 and an inner pleat distance 48, the pleat distance 48, 50 being measured as a distance between two neighboring pleat folds 20, 24 along the circumferential direction 46, are defined in FIG. 6. In an embodiment of the filter element 10, a minimum width of the inner pleat lock deformation 26 may be 70%, for example 75%, for example 80%, for example 85%, of the inner pleat distance 48 without pleat lock deformations 26.

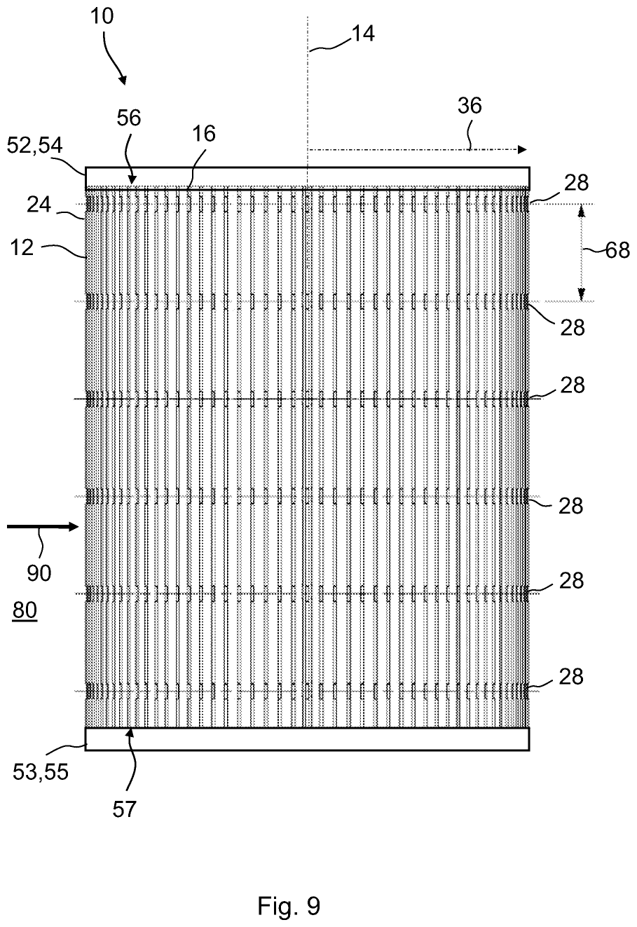

FIG. 9 depicts a side view of the filter element 10 with end caps 54, 55 according to an embodiment of the invention.

The filter element 10 comprises end bodies 52, 53 at both ends of the filter media bellows 12, realized as end caps 54, 55, closing the filter media bellows 12 at one axial end 56, 57 in a fluid-tight manner. For example, the end cap 55 may be a closed end cap, whereas the end cap 54 may be an open end cap as an outlet for the filtered fluid.

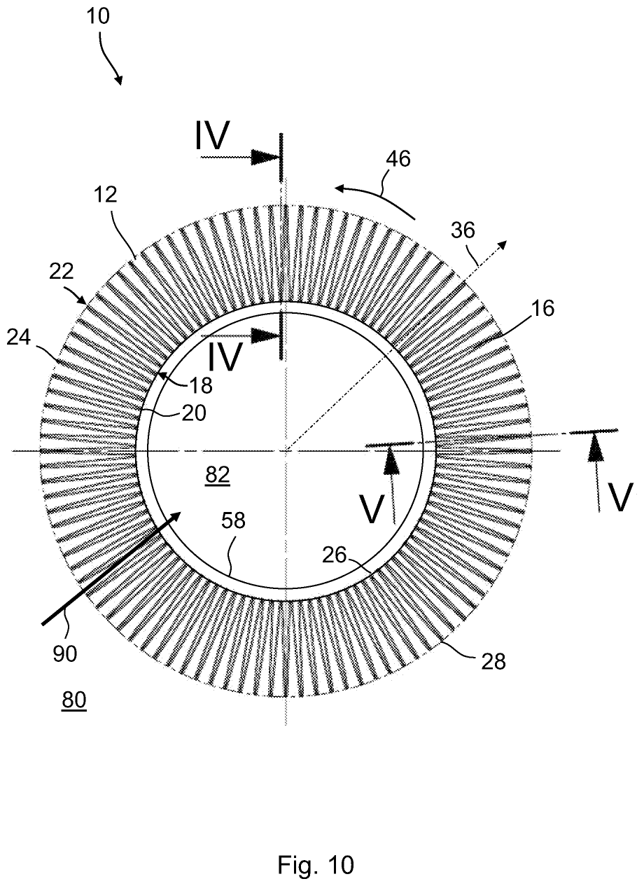

FIG. 10 depicts a top view of the pleated filter media bellows 12 according to FIG. 1 with a support body 58.

As depicted, the filter element 10 comprises a fluid-permeable support body 58, for example a support grid, arranged at the inner circumference 18 of the filter media bellows 12. The support body 58 extends at least partially in the circumferential direction 46. For example, the support body 58 is adapted and configured to support at least some of the inner pleat folds 20 against deformation in the radial direction 36.

### REFERENCE NUMERALS

10 filter element
12 filter media bellows
14 longitudinal axis
16 pleat
18 inner circumference
20 inner pleat fold
22 outer circumference
24 outer pleat fold
26 inner pleat lock deformation
28 outer pleat lock deformation
30 longitudinal extension
32 depth of inner pleat lock deformation
34 depth of outer pleat lock deformation
36 radial direction
38 length of inner pleat lock deformation
40 length of outer pleat lock deformation
42 width of inner pleat lock deformation
44 width of outer pleat lock deformation
46 circumferential direction
48 inner pleat distance
50 outer pleat distance
52 end body
53 end body
54 end cap
55 end cap
56 axial end
57 axial end
58 support body
60 angulation of inner pleat lock deformation
62 angulation of inner pleat lock deformation
64 angulation of outer pleat lock deformation
66 angulation of outer pleat lock deformation
68 distance between pleat locks
70 pleat height
80 raw side
82 clean side
90 flow direction

That which is claimed is:

1. A filter element comprising:
a pleated filter media bellows extending at least partially circumferentially about a longitudinal axis,
wherein pleats of the filter media bellows extend essentially parallel to the longitudinal axis,
and wherein the filter media bellows comprises inner pleat folds at an inner circumference and outer pleat folds at an outer circumference,
and wherein at least one inner pleat fold and at least one outer pleat fold each comprise a pleat lock deformation with an extension along the longitudinal axis that is smaller than a total longitudinal extension of the filter media bellows.

2. The filter element according to claim 1, wherein the inner and outer pleat lock deformations comprise a predefined depth in a radial direction, a predefined length, in the longitudinal direction and a predefined width in a circumferential direction.

3. The filter element according to claim 2, wherein:
the width of the inner pleat lock deformation is larger than the width of the outer pleat lock deformation, and/or
the depth of the inner pleat lock deformation is larger than the depth of the outer pleat lock deformation.

4. The filter element according to claim 3, wherein the width of the inner pleat lock deformation is at least 20% larger than the width of the outer pleat lock deformation.

5. The filter element according to claim 3, wherein:
the depth of the inner pleat lock deformation is at least 30% larger than the depth of the outer pleat lock deformation.

6. The filter element to according to claim 1, comprising additional inner pleat lock deformations at every n-th inner pleat fold, with n being a natural number.

7. The filter element according to claim 1, comprising a multitude of the inner pleat lock deformation with an inner pleat lock deformation at every inner pleat fold.

8. The filter element according to claim 3, wherein:
the width of a multitude of the inner pleat lock deformations is larger on an average than the width of the outer pleat lock deformation and/or
the depth of a multitude of the inner pleat lock deformations is larger on an average than the depth of the outer pleat lock deformation.

9. The filter element according to claim 8, wherein:
the width of a multitude of the inner pleat lock deformations is at least 20% larger on an average than the width of the outer pleat lock deformation.

10. The filter element according to claim 8, wherein:
the depth of a multitude of the inner pleat lock deformations is at least 30% larger on an average than the depth of the outer pleat lock deformation.

11. The filter element according to claim 7, wherein:
the inner pleat lock deformations abut against each other in an intended state of use of the filter element.

12. The filter element according to claim 7, wherein:
the inner pleat lock deformations are arranged at the same longitudinal position so as to lie in a common plane, the common plane extending in a direction normal to the longitudinal axis.

13. The filter element according to claim 1, wherein multiple inner pleat lock deformations are provided at a common inner pleat fold and are spaced apart from each other along the longitudinal direction.

14. The filter element according to claim 1, wherein:
a multitude of the inner and/or outer pleat lock deformations are formed as local geometry deviations of the inner and/or outer pleat fold in that a local pleat cross-section deviates from a pleat cross-section along a major part of the pleat's longitudinal extension.

15. The filter element according to claim 1, wherein:
the filter media bellows comprises an outer pleat distance and an inner pleat distance, the pleat distance being measured as a distance between two neighboring pleat folds along the circumferential direction, and
wherein the inner pleat lock deformation comprises a minimum width of 70% of an inner pleat distance without pleat lock deformations.

16. The filter element according to claim 1, comprising at least one end body defining an end cap, closing the filter media bellows at one axial end in a fluid-tight manner.

17. The filter element according to claim 1, comprising a fluid-permeable support body in the form of a support grid, arranged at the inner circumference of the filter media bellows and extending at least partially in the circumferential direction, wherein the support body is adapted and configured to support at least some of the inner pleat folds against deformation in the radial direction.
